(19) United States
(12) Patent Application Publication
(10) Pub. No.: US 2007/0016654 A1
(43) Pub. Date: Jan. 18, 2007

(54) Wireless content distribution

(75) Inventors: Mark V. Bowles, San Diego, CA (US); Eric Rosser, San Diego, CA (US); Jason L. Ellis, San Diego, CA (US); Gaetano Roberto Aiello, San Diego, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/484,882

(22) Filed: Jul. 11, 2006

Related U.S. Application Data
(60) Provisional application No. 60/699,068, filed on Jul. 13, 2005.

(51) Int. Cl. G06F 15/16

(52) U.S. Cl. 709/217

(57) ABSTRACT

Distributing content between media devices is disclosed. An item stored on a first media device is selected for distribution. A distribution type associated with the item is specified, where the distribution type is indicative of a compensation arrangement. A copy of the item is transferred to a second media device.

### CROSS REFERENCE TO OTHER APPLICATIONS

This application claims priority to U.S. Provisional Patent Application No. 60/699,068 (Attorney Docket No. AIELP040+) entitled PROTECTED CONTENT WIRELESS DISTRIBUTION filed Jul. 13, 2005 which is incorporated herein by reference for all purposes.

### BACKGROUND OF THE INVENTION

With the growth of broadband networking, Internet based file sharing has become popular in recent years. Although many legitimate uses exist, distribution schemes such as peer-to-peer distribution networks (e.g., over the Internet) have acquired a somewhat illegitimate reputation since the content “shared” is often pirated material distributed without authorization.

Users now have the option to legally purchase copyrighted content including music, video, and/or other content from online stores such as iTunes™. These online stores usually require the user to sign up for a subscription based service or pay for individual content. Typically, the user authenticates with the online store and directly downloads the content from the servers associated with the online stores. Although the online stores are useful for allowing consumers to legally obtain copyrighted material, there are still some unmet needs. For example, Internet access, preferably high speed Internet access, is required for downloading purchased content. Users are usually required to have registered for an account with a particular store. Although people often want to spontaneously share music, videos, or other content from their purchased collections when they have fact-to-face interactions, it is difficult or impossible for them to do so when Internet access is not easily available and/or because the devices themselves and the software they run aren't designed to allow sharing of content. It is therefore desirable to provide an easier way to legally share copyright protected content, (e.g., directly from device to device), both when Internet/Intranet access is available and unavailable. It would also be useful if, by providing a better way of legitimately distributing protected content, service providers such as wireless service carriers could offer more services and create new revenue streams.

### BRIEF DESCRIPTION OF THE DRAWINGS

Various embodiments of the invention are disclosed in the following detailed description and the accompanying drawings.

FIG. 1 is a block diagram illustrating an embodiment of a system in which devices can share content.

FIG. 2 is a flowchart illustrating an embodiment of a process for content distribution.

FIG. 3 is a flowchart illustrating an embodiment of a process for handling a received item.

FIG. 4 is a block diagram illustrating a wireless network embodiment that facilitates content sharing.

FIG. 5 is a flowchart illustrating an embodiment of a process for content distribution.

FIG. 6A is a block diagram illustrating a transmitter embodiment used in some media devices.

FIG. 6B is a block diagram illustrating a receiver embodiment used in some media devices.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A content sharing technique has been disclosed. The technique is applicable for distributing copyright protected content including audio/video, digital books, software, and any other works of authorship under protection of copyright law, and non-copyright protected content, as well as non-copyrighted material such as works in the public domain. In some embodiments, the sender specifies a distribution type associated with the item he selected for distribution. The distribution type indicates a compensation arrangement for the payment for the item. In some embodiments, the sender and the recipient's media devices include wireless transceivers such as Ultra Wideband (UWB) transceivers for exchanging content wirelessly. In other embodiments a wired connection is used.

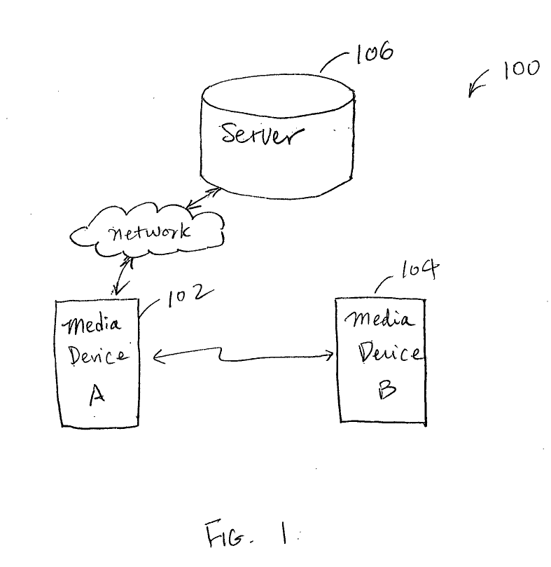

FIG. 1 is a block diagram illustrating an embodiment of a system in which devices can share content. In this example, system 100 includes a number of media devices such as 102 and 104, and a server 106. Although additional media devices and/or servers are allowable, a limited number of elements are shown for purposes of illustration. The media devices, in this illustration, are portable devices capable of storing and playing media content, such as audio-video file players (e.g. MP3 players), multimedia enabled personal digital assistants (PDAs), personal media players (playing video content) and mobile phones. Some media devices are configured to not only play content (e.g., music, video, and/or multimedia), but can also store content to be played in conjunction with other devices. For example, some personal media players include a storage drive or a disk drive that can be connected to speakers or monitor to view and/or hear content. The media devices are capable of communicating with each other and transferring data according to a specific protocol. In some embodiments, the media devices include wireless transceivers that allow the devices to communicate via a wireless connection. Examples of the wireless transceivers include Ultra Wideband (UWB) transceivers that conform to standards such as IEEE 802.11(b)(g)(a), Ecma-368, WiMedia Alliance, and 802.15.4a, Wireless Personal Area Network (WPAN) transceivers such as Bluetooth, Certified Wireless Universal Serial Bus (USB), Wireless 1394 devices, WiFi, etc.

At least one of the media devices is capable of communicating with a server 106 at least some of the time. In the example shown, media device 102 communicates with server 106 via a network. The network may be an open access network such as the Internet, or a proprietary network such as a telephony network or Intranet. The physical layer of the network may include wire lines, wireless radio links, or a mixture. As will be shown in more detail below, the server includes one or more machines capable of authenticating users/devices and tracking transactions between the media devices. In some embodiments, the server also functions as a content server that allows subscribers to purchase and download content, a log server that records user activities, and/or a billing server that generates billing information. Additional functions may be provided by the server as appropriate.

For purposes of the following discussion, it is assumed that the users (e.g., 102 or 104) in the system have made agreements with the provider of the system and owners of the content to allow legal content distribution to take place. The sender (either 102 or 104), the recipient (either 102 or 104), or both are required to give some form of payment to obtain the rights to the copyrighted content. Credits or other incentives may be given for successful distribution. Monetary payments are discussed for purposes of illustration, although other forms of payment such as points, credits or other incentives can also be used depending on the arrangements between the copyright owner, the service provider, and the end users. Users may pay per transaction, pay a fixed amount for a number of transactions, pay a subscription and be able to have an unlimited number of transactions, or have time based subscriptions (e.g., where content is accessible for a certain period of time), etc. Many other types of arrangements are possible. Details of the distribution process are discussed in further detail below.

In some embodiments, Media Device B is a personal media player and/or Media Device A is a cable operator set-top-box (e.g., with or without DVR). The closed network may be a connection to a cable operator's content server (106); whereby user of Media Device B can obtain content, such as movies or other protected programming, from the network or from a DVR (digital video recorder), for viewing or transport via a personal media player.

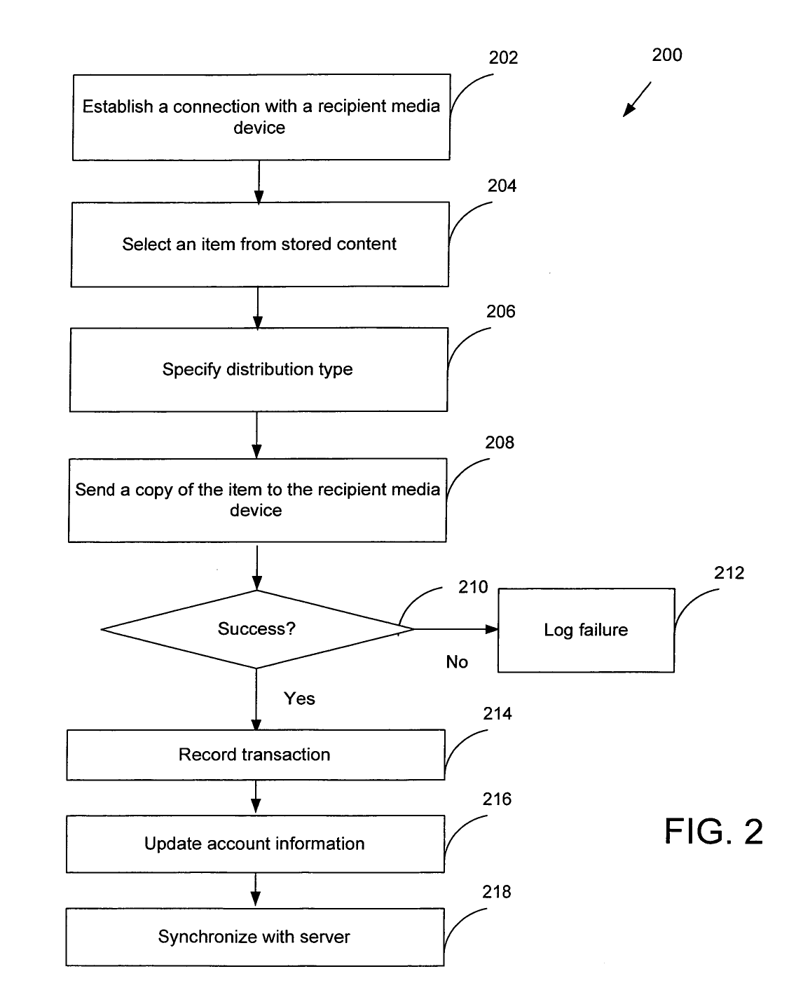

FIG. 2 is a flowchart illustrating an embodiment of a process for content distribution. Process 200 may be implemented on any media device and is carried out by a sender's media device. The sender has an account with the service provider, and his activities are tracked by the server. In this example, the process initiates when the sender is ready to transfer content to a recipient. A connection is established between the sender's media device and the recipient's media device (202). The connection is established according to the communications protocol supported by the media devices. For example, in some embodiments both the sender and the recipient devices include UWB transceivers. In addition to establishing the connection over the transport layer, some embodiments also implement handshakes for establishing the connection at the application layer. For example, the sender's media device may query the recipient's media device to determine whether the recipient is a registered user, whether the recipient's device has sufficient storage space to hold the incoming content, whether the particular content already exists on the recipient's device, whether the recipient's device support certain file format and has the necessary software for processing the content, and any other relevant information that helps determining whether the transaction should take place. If the handshake is successful, the connection is established and the process is allowed to proceed.

An item from the content stored on the media device is selected for distribution (204). The distribution type associated with the item is specified (206). The distribution type indicates a compensation arrangement. Usually, it indicates the particular payment scheme the sender wants to use for this distribution. The sender can send the item as a gift to the recipient by choosing to be responsible for the payment of the transferred content. Alternatively, the sender could choose to provide the content and “go Dutch” with the recipient responsible for the payment. In some embodiments, copyright protected content is transferred as a promotional item that requires the recipient to make a full payment to gain full access to the item. Some embodiments also allows the sender to “sell” his copy to the recipient. In other words, once the sender transfers a copy of the item to the recipient's device, the copy residing on the sender's media device is automatically removed or otherwise rendered unusable, thus only a single paid for copy is in circulation. Other payment schemes and distribution types are possible. In some embodiments, certain restrictions exist and operations are only allowed to proceed if the restrictions are met. For example, some systems only allow the sender to give a limited number of items as gifts, or only allows the sender to give gifts if he has a positive account balance. Such restrictions prevents the sender from giving away a large number of items without eventually paying. In some embodiments, a sender may pre-purchase the right to gift content to others or have established a certain amount of credit that is bestowed upon the sender, such that content can be shared without immediate connection to an Internet or Intranet network.

A copy of the item is sent to the recipient's media device over the wireless connection (208). In some embodiments, information that determines the recipient's access rights to the item is sent along with the content data. The recipient may have full or partial access to the item depending on the distribution type. The information can be stored as a part of the item being downloaded (such as one or more header fields indicating the level of access) or separate from the content data. In some embodiments, the data transferred between the devices is encrypted using techniques such as public-private key cryptography where the sender's media device receives a public key from the recipient's media device, encrypts the content to be transferred using the public key, and downloads the encrypted content to the recipient's device. The recipient's device can decrypt the content received using its private key. Additional data may also be sent. For example, when sending a promotional item, the sender can sometimes send the recipient a coupon so should the recipient decide to purchase the item, he can get a discount on the purchase price.

It is determined whether the download is successful (210). If not, the failed transaction is optionally recorded (212). Recorded information may include the identities of the sender and the recipient, the item sent, the length of transaction, etc. If the download is successful, the transaction is also recorded (212). Account information is optionally updated (216). The update is based at least in part on the distribution type, and includes information regarding billing, credit, payment, etc. In some embodiments, the account information includes incentive information that rewards the sender for sharing content with others. For example, a sender may receive certain credits for successful distributions. The rules for providing incentive vary and are configurable. For example, some systems apply credits depending on the distribution type. A gift, a promotion that was never turned into a purchase by the recipient, and a promotion that turned into a purchase result in different amounts of credits. Some systems allow multi-tiered incentive structure, where a sender receives credits for distributing to the recipient, and from other recipients who received the same content from the original recipient, and so on.

In this example, the transaction and account information is stored on the sender's media device initially. At a later time, the sender logs on to the server either directly using his media device, or via a computer that provides docking capabilities for the media device and retrieves information from the media device upon docking. The information accumulated on the sender's media device is sent to the server directly or via the docking computer, and is synchronized with records on the server (218). For example, if the sender has selected a distribution type indicating that the sender is paying for at least a part of the item, the payment may be charged to the sender to be billed later, or deducted from credits previously purchased by the sender and stored in the server's account. After the synchronization, the log and transaction information stored on the recipient's media device is cleared or otherwise marked as having been updated. In some embodiments, the sender's media device maintains a server connection that is substantially coextensive in time as the connection with the recipient's media device. In such case it is not necessary to store the transaction and account information on the sender's device since the information can be directly transferred and updated on the server via the open connection between the sender's media device and the server. One example of this is a media device that is connected to a mobile phone carrier network, whereby immediate wireless authentication or billing can transpire (e.g., via the mobile phone carrier network) but the actual content is shared between devices when permitted.

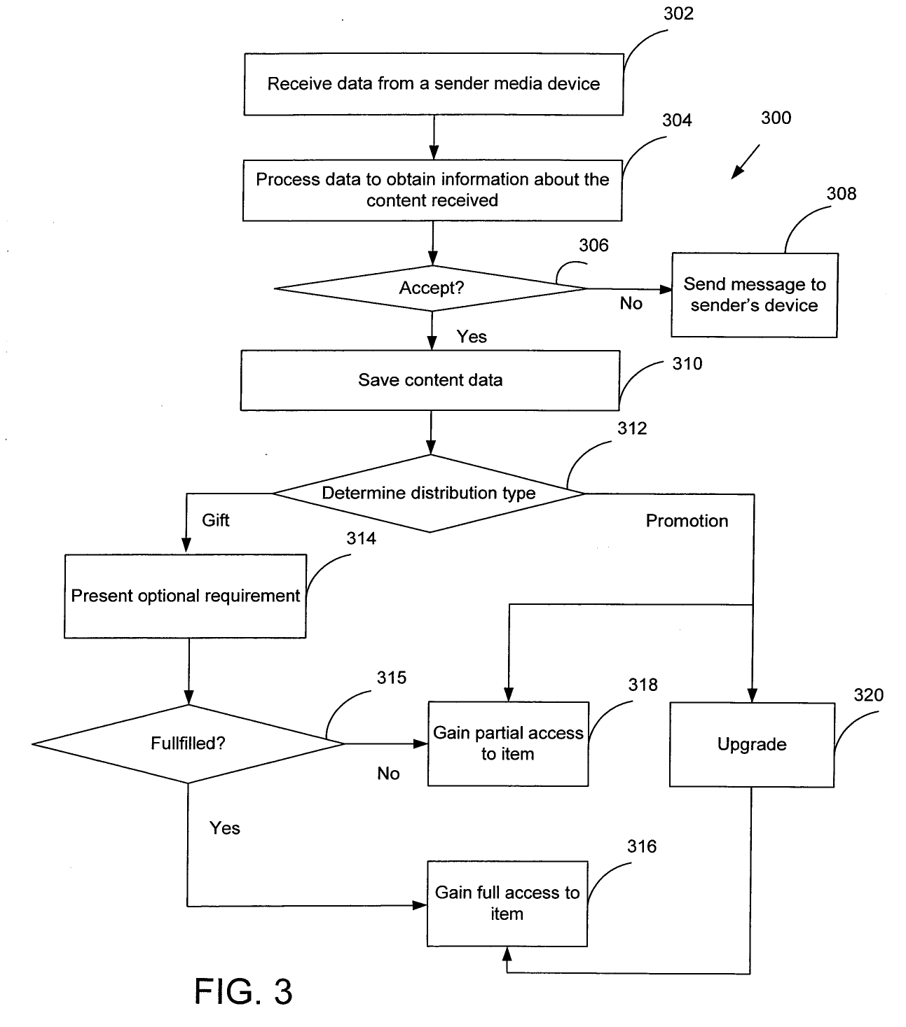

FIG. 3 is a flowchart illustrating an embodiment of a process for handling a received item. The process may be implemented on any media device, and is carried out by a recipient's media device. In this example, process 300 initiates when data is received from a sender's media device (302). In some embodiments, the data is encrypted by the sender's media device, and is decrypted once received. The data is processed to obtain information such as information about the content that is received (title, artist, summary, etc.), the distribution type, etc. (304). The recipient user is presented with relevant information, and given the option to accept or reject the item (306). If the recipient chooses to reject the item, the content is not saved and a message is optionally sent to the sender's media device indicating that the transfer has been refused (308). The transaction is optionally recorded. If, however, the recipient accepts, the content is saved on the recipient device (310). The distribution type associated with the item is determined (312). The determination can be made, for example, by examining a header field of the content data, examining a message or a part of a message received along with the content data, or any other appropriate techniques.

If the item received is deemed to be a gift, it indicates that the sender has paid or will be paying for the item. In some embodiments, the recipient gains full access to the item and can enjoy the item the same way as the sender, whether or not the recipient is able to access the server that tracks the sender's activities. In the example shown, certain optional requirements (such as a user agreement with terms of use for the service, a survey to supply certain information, etc.) are presented to the recipient (314). If the optional requirements are fulfilled by the recipient, he gains full access to the item (316). If, however, the recipient chooses not to fulfill the optional requirements, he only gains partial access to the item (318). For example, the recipient's media device may play the content at a lower resolution or only play a part of the content, the content may expire and become inaccessible after being played a certain number of times or after a certain period of time, or a restriction is imposed on the content preventing it from being shared further.

If the item received is deemed to be a promotional item, it indicates that the recipient only has partial access to the item initially (318). The recipient can choose to upgrade by, among other things, paying for the item or agreeing to pay for the item (320). For example, the recipient can upgrade by logging on to the server and paying for the item, or debiting the cost of the item locally using digital cash stored on the media device. The recipient can also agree to pay for the item and be billed later. The agreement may be communicated to the server directly at the time the transaction takes place, or stored on the media device temporarily then resolved at a later time when the recipient logs on to the server. Once an upgrade is carried out, the recipient gains full access to the item (316).

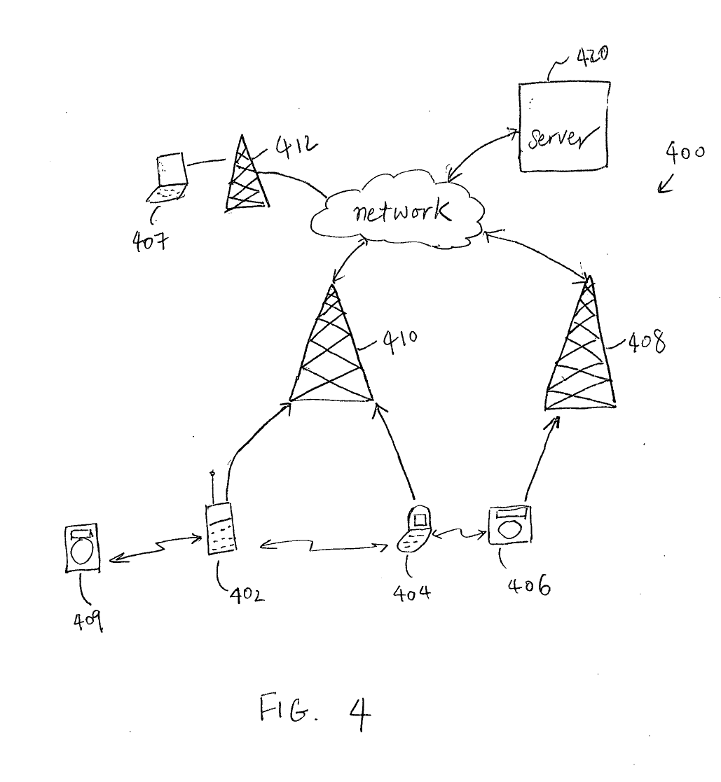

FIG. 4 is a block diagram illustrating a wireless network embodiment that facilitates content sharing. In this example, media devices 402-407 are mobile devices that subscribe to one or more services provided by wireless network 400. The wireless network is configured to support one or more standards such as GSM, CDMA, WAP, Wi-Fi, WiMax, etc. to provide voice, video, email/data, as well as any other appropriate wireless service over a relatively wide graphical area; alternatively, this network could be a wired network or a combination of wired and wireless. The mobile devices access the network via access devices such as 408-410. Examples of the access devices include wireless base stations implementing wireless telephony services according to protocols such as GSM, CDMA, wireless access point devices implementing wireless data services according to protocols such as Wi-Fi, WAP, etc.

Examples of the mobile devices include mobile phones, mobile email devices, as well as integrated multi-purpose devices. Mobile device 402 is a mobile phone that includes a first communications interface configured to send and receive information via the wireless network, and a second communications interface configured to exchange data with other devices. Some mobile devices use the same physical interface to send and receive information via the network and share content with other mobile devices. In some embodiments different types of communications interfaces are used since the data rate required to provide acceptable service via network 400 can be different from the data rate required to provide satisfactory user experience during content distribution. Further, content sharing often takes place during face to face interactions where the users are located in close proximity, while authentication and information transfer with the server/wireless service can take place over a wide geographical area. Accordingly, the separate interfaces supporting different protocols are used in some embodiments. In some embodiments the first communications interface supports a lower data rate and transfers data at a higher power over a greater distance than the second communications interface. For example, the first communications interface used by some devices include GSM or CDMA transceivers that typically operate at approximately 20-40 dBm and transfer data on the order of 100 kb/s-1 Mb/s within a distance of several kilometers. The second communications interface used by some mobile devices includes low power, spread spectrum modulated transceivers for providing high data rates within a limited area, such as Ultra-Wideband transceivers that typically operate at approximately −40-−70 dBm of power, and transfer data on the order of 100 Mb/s-1 Gb/s within a distance of approximately 10 meters or so. An example of a UWB transceiver is described below.

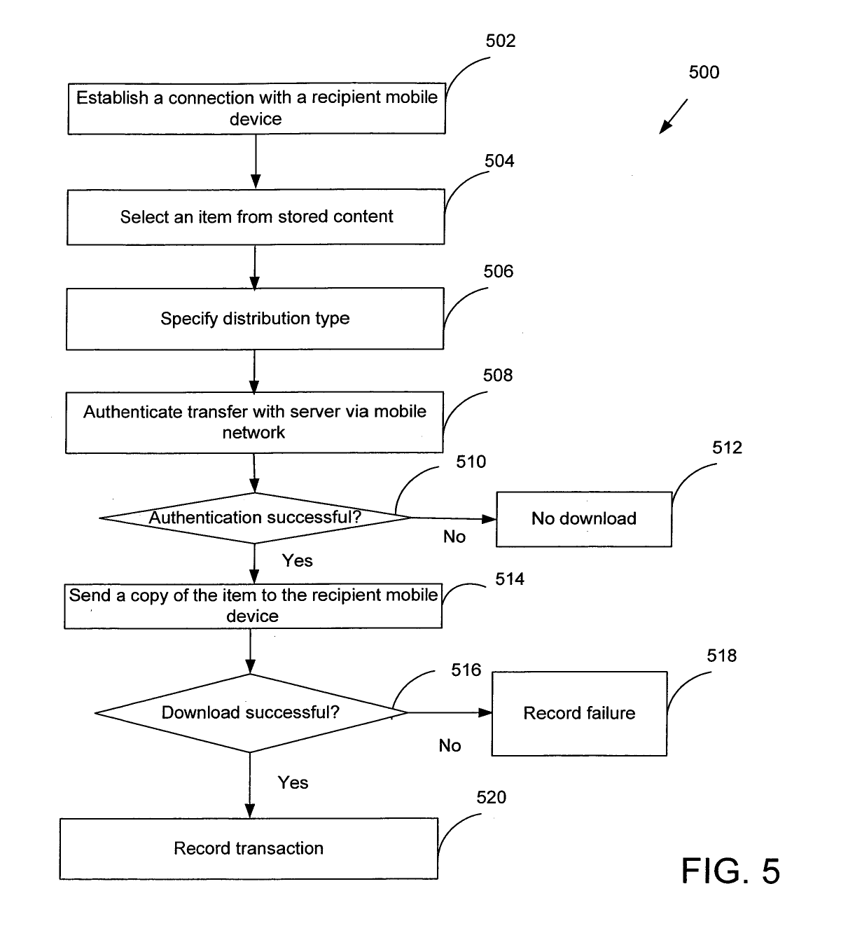

FIG. 5 is a flowchart illustrating an embodiment of a process for content distribution. Process 500 may be implemented on a mobile device such as 402 of FIG. 4. In this example, the process initiates when a connection is established between the sender mobile device and the recipient mobile device (502). The connection is established directly from the sender's media capable device to the recipient's media device according to the communications protocol supported by the media devices. An item from the content stored on the sender's mobile device is selected for distribution (504). The distribution type associated with the item is specified (506). Before downloading the content to the recipient's device, the sender authenticates with the server using his mobile device via the mobile network to verify that he is authorized to make the distribution (508). In some embodiments, the verification is done using the existing connection between the sender's mobile device and the server. Information such as identifiers for the sender, the recipient, the mobile devices, the item being sent, etc. is automatically sent to the server, and the sender is automatically authenticated. In some embodiments, the sender logs on to the server manually to complete the authentication. In some embodiments, verification at 508 is performed via a connection other than the connection established at 502. For example, in some embodiments verification is performed using another connection such as a Bluetooth connection.

It is determined whether the authentication is successful (510). The authentication may fail for a variety of reasons, many of which are configurable by the system administrator. For example, some systems check the sender's payment history and prevent further distribution if payment due has not been received. Some systems only allow distribution to a limited group of recipients, such as existing subscribers to the service. If the authentication is not successful, download is prohibited (512) and the process completes. Information about the failed authentication is optionally recorded. If the authentication is successful, a copy of the item is then allowed to be sent (e.g., via the local connection establish in 502) to the recipient's device (514). It is determined whether the download is successful (516). The successful or failed transaction is recorded accordingly (518 and 520).

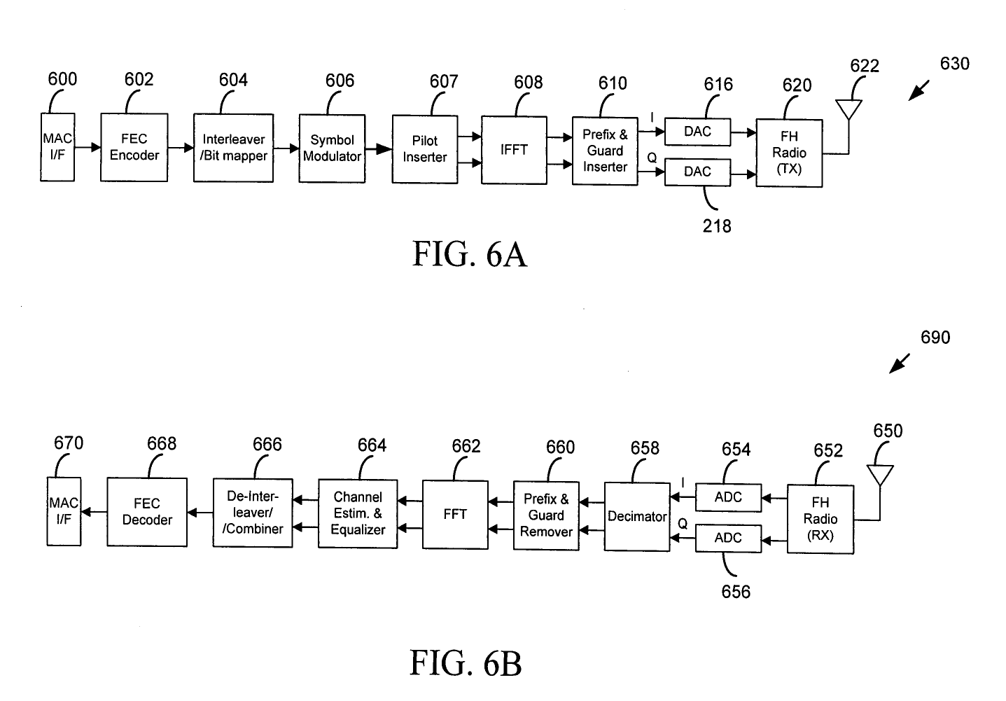

FIG. 6A is a block diagram illustrating a transmitter embodiment used in some media devices. Transmitter 630 shown in this example is a UWB transmitter that employs Orthogonal Frequency Division Multiplexing (OFDM). Data bits received on medium access control (MAC) interface 600 are encoded by a forward error correction (FEC) encoder 602. The encoded bits are then interleaved and mapped to a transmission data sequence by an interleaver/bit mapper combination 604. The interleaver reorders the data bits to avoid transmitting successive code bits on neighboring sub-carriers in the same OFDM symbol, since adjacent sub-carriers tend to be subject to similar multipath and fading conditions. In some embodiments, the code bits are interleaved across several OFDM symbols.

The bit mapper performs one or more mapping operations on the data bits. As will be discussed in more details below, the bits may be mapped in a reverse order, in a shifted order, in the same order or in combinations thereof. The resulting data sequence is later transmitted in an OFDM symbol. In some embodiments, the bit mapper applies several mapping operations to the input bit sequence to generate several mapping results that are transmitted in a plurality of OFDM symbols. In some embodiments, the bit mapper applies a mapping operation to the input bit sequence to obtain a mapping result to be transmitted in an OFDM symbol, and then applies a second mapping operation to the mapping result to generate another output to be transmitted in another OFDM symbol. In embodiments where multiple mapping operations are used, the functions performed by these operations may be the same or different depending on system implementation. Mapping spreads the bandwidth of the transmitted signal beyond the information bandwidth, introduces additional frequency diversity and makes the transmitted signal more robust against multipath and interference.

The interleaved and repeated bits are then modulated into symbols by a symbol modulator 606. The example shown employs QPSK modulation, where consecutive bits are collected in pairs and then mapped onto a QPSK symbol. Other appropriate modulation techniques may be used as well. Pilot tone inserter 607 inserts pilot tones into the modulated symbols. An Inverse Fast Fourier Transform (IFFT) component 608 is used to transform blocks of symbols into a time domain waveform (also referred to as an OFDM symbol). In some embodiments, each OFDM symbol is repeated before a preamble, a guard interval and a cyclic/zero prefix are added to the OFDM symbol by prefix and guard inserter 610. In some embodiments, interpolation and amplitude clipping are optionally applied to the OFDM symbol. The inphase (I) and quadrature (Q) components of the baseband OFDM signal are converted from digital to analog by digital to analog converters (DACs) 616 and 618, respectively. The analog signals are sent to a radio transmitter 620 and transmitted via antenna 622.

FIG. 6B is a block diagram illustrating a receiver embodiment used in some media devices. In this example, receiver 690 is a UWB receiver. An OFDM signal is received on antenna 650 by radio receiver 652, which divides the signal into I and Q components and converts the signal to baseband. Analog to digital converters (ADCs) 654 and 656 convert the baseband signal to digital. In some embodiments, the digital baseband signal is optionally processed by a decimation stage 658. The prefix and guard intervals remover 660 removes the prefix and guard intervals. A Fast Fourier Transform (FFT) component 662 converts the time domain OFDM waveforms to frequency domain samples. Channel estimator and equalizer 664 processes the frequency domain samples to mitigate the effects of multipath propagation. After equalization, the repeated OFDM symbols are combined to 1 OFDM symbol. In this example, each received sub-carrier sample may be viewed either as a noisy QPSK symbol, or as a pair of noisy BPSK symbols taken from the real and imaginary part of the QPSK symbol. In both cases, the symbols are referred to as soft symbols.

The soft symbols are fed to deinterleaver/combiner 666, which performs the inverse function of interleaver/bit mapper 604 of FIG. 6A. Multiple received instances of the same soft symbol are combined into one. Combining can be implemented in various ways. In some embodiments, Maximal-Ratio (MR) combining is used, in which each soft symbol instance is weighted with the estimated amplitude of the sub-carrier on which it was received. The weighted soft symbols are then summed to obtain a single instance. Next, the resulting soft BPSK symbols are de-interleaved to reverse the operation of the interleaver. The sequence of de-interleaved BPSK symbols is decoded by FEC decoder 668. The decoded signal is sent to MAC interface 670 to be further processed.

In some embodiments, transmitter 630 and receiver 690 are combined to form a transceiver, which can be implemented using Application Specific Integrated Circuits (ASIC), programmable Digital Signal Processor (DSP), general purpose processor, or any other appropriate hardware, software, and/or firmware combination.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of distributing content between media devices, comprising:
selecting an item stored on a first media device for distribution;
specifying a distribution type associated with the item, the distribution type being indicative of a compensation arrangement; and
transferring a copy of the item to a second media device.

2. A method as recited in claim 1, wherein the item is a copyright protected item.

3. A method as recited in claim 1, wherein the distribution type indicates that the copy of the item being sent is to be paid at least in part by a sender of the copy.

4. A method as recited in claim 1, further comprising recording transaction on a server.

5. A method as recited in claim 1, further comprising storing transaction information on the first media device, and synchronizing the stored transaction information with a server.

6. A method as recited in claim 1, further comprising authenticating with a server to arrange for payment of the copy.

7. A method as recited in claim 1, wherein the distribution type indicates that the copy of the item being sent is to be paid at least in part by a recipient of the copy.

8. A method as recited in claim 1, further comprising updating account information associated with a sender of the data.

9. A method as recited in claim 8, wherein updating account information includes updating a reward given to the sender for transferring the item.

10. A method as recited in claim 9, wherein the reward is determined based at least in part on the distribution type.

11. A method as recited in claim 1, wherein the first media device is a mobile device.

12. A method as recited in claim 1, wherein the first media device is a mobile device configured to send and receive information via a wireless network.

13. A method as recited in claim 1, wherein the first media device is a mobile device having a first wireless interface configured to transfer data via a wireless network, and a second wireless interface configured to directly transfer data to the second media device.

14. A method as recited in claim 13, wherein the second wireless interface supports a higher data rate than the first wireless interface.

15. A method as recited in claim 1, wherein the first media device includes an Ultra-Wideband transmitter.

16. A media device comprising:
a processor configured to:
select an item stored on a the media device for distribution;
specify a distribution type associated with the item, the distribution type being indicative of a compensation arrangement; and
transfer a copy of the item to another media device.

17. A computer program product for distributing content between media devices, the computer program product being embodied in a computer readable medium and comprising computer instructions for:
selecting an item stored on a first media device for distribution;
specifying a distribution type associated with the item, the distribution type being indicative of a compensation arrangement; and
transferring a copy of the item to a second media device.
